(19) United States
(12) Patent Application Publication
(10) Pub. No.: US 2009/0135680 A1
(43) Pub. Date: May 28, 2009

(54) COLOR CHANGING PERSONAL ARTICLES

(75) Inventor: David A. Rosales, Dallas, TX (US)

Correspondence Address: FISH & RICHARDSON P.C., P.O. BOX 1022, MINNEAPOLIS, MN, 55440-1022, US

(73) Assignee: Fossil, Inc., Richardson, TX (US)

(21) Appl. No.: 12/265,670

(22) Filed: Nov. 5, 2008

Related U.S. Application Data
(60) Provisional application No. 60/985,591, filed on Nov. 5, 2007.

(51) Int. Cl. G04C 17/00; G04C 19/00

(52) U.S. Cl. 368/242; 368/239

(57) ABSTRACT

In various implementations, a personal article or a portion thereof may be able to change colors. The personal article may transmit a first range of wavelengths of light and upon activation transmit a second range of wavelengths of light different from the first range of wavelengths of light.

### CLAIM OF PRIORITY

This application claims priority under 35 U.S.C. §119 to U.S. Provisional Patent Application Ser. No. 60/985,591, filed on Nov. 5, 2007, the entire contents of which are hereby incorporated by reference.

### TECHNICAL FIELD

The present disclosure relates to personal accessories.

### BACKGROUND

Personal articles, such as watches, are often manufactured in specified colors. Often, users like to wear watches of different colors based on clothing, jewelry, fashion trends, mood, or other factors. While bands of a watch can be replaced easily, other colors of a watch, such as the face of a watch or other images on the watch, are fixed. Thus, the user may have to purchase a new watch for each color desired.

### SUMMARY

In various implementations, a personal article or portion thereof may be able to change colors. The personal article may transmit a first range of wavelengths of light and, upon activation, transmit a second range of wavelengths of light different from the first range of wavelengths of light.

In one general aspect, a timepiece includes a first polarizer, a second polarizer, a retarder or retarder stack, and one or more adapters. The first polarizer and the second polarizer are configured to polarize light from a light source. The retarder stack is disposed between the first polarizer and the second polarizer and is configured to orthogonally polarize at least a portion of light from the light source. The adapters are coupled to and operable to rotate one of: the first polarizer, the second polarizer, the third polarizer and/or the retarder stack. The timepiece transmits a first range of wavelengths of light and rotation causes the timepiece to transmit a second range of wavelengths of light different from the first range of wavelengths of light. In some implementations, components such as polarizers and/or retarders may be rotated in increments and at each different increment of rotation, a different transmission range of wavelengths of light can be achieved.

Various implementations may include one or more of the following features. The timepiece may include a movement disposed proximate at least one of the first or the second polarizer. The movement may be operable to rotate one of the adapters, and the second range of wavelengths of light transmitted by the timepiece upon rotation may change as the movement rotates the adapter. The timepiece may include an insignia and rotation may cause the insignia to change colors due to the transmission of the second range of wavelengths of light. The timepiece may include a background. The rotation may cause the background to change colors due to the transmission of the second range of wavelengths of light and may not affect the transmission of light by the insignia. At least one of the adapters may include a bezel of a watch, a stem of a watch, or a portion of at least one of the first polarizer, the second polarizer, or the retarder stack, where the portion is accessible to a user. The timepiece may include a light source disposed in a cavity of the timepiece and proximate the second polarizer. The timepiece may include a reflector disposed in the cavity of the timepiece and proximate the second polarizer.

In another general aspect, a timepiece includes a liquid crystal layer and a retarder stack disposed in a cavity of the timepiece. The retarder stack is proximate the liquid crystal layer. The timepiece also includes one or more adapters operable to, when activated, alter the electromagnetic field applied to the liquid crystal layer. The timepiece transmits a first range of wavelengths of light and activation of the adapter causes the timepiece to transmit a second range of wavelengths of light different from the first range of wavelengths of light.

Various implementations may include one or more of the following features. The liquid crystal layer includes a twisted nematic liquid crystal layer or a super-twisted nematic liquid crystal layer. The timepiece may include a movement disposed proximate the retarder stack. The movement may be operable to activate one of the adapters, where the second range of wavelengths of light transmitted by the timepiece upon rotation changes as the movement activates the adapter. The timepiece may include insignia and activation may cause the insignia to change colors due to the transmission of the second range of wavelengths of light. The timepiece may include a background. The rotation may cause the background to change colors due to the transmission of the second range of wavelengths of light and may not affect the transmission of light by the insignia. At least one of the adapters includes at least one of a stem of a watch or a bezel of a watch, where rotation of the bezel activates the at least one of the adapters. The timepiece may include at least one of a light source disposed in a cavity of the timepiece and proximate the retarder stack or a reflector disposed in the cavity of the timepiece and proximate the retarder stack. In some implementations, a liquid crystal may be incrementally activated and at each different increment of activation of the liquid crystal layer, a different transmission range of wavelengths of light can be achieved.

In another general aspect, a personal article includes a first polarizer and a second polarizer configured to polarize light from a light source, a retarder stack disposed between the first polarizer and the second polarizer and configured to orthogonally polarize at least a portion of light from the light source, and one or more adapters. The adapters are coupled to and operable to rotate one of the first polarizer the second polarizer, the third polarizer, or the retarder stack, where the personal article transmits a first range of wavelengths of light and rotation causes the personal article to transmit a second range of wavelengths of light different from the first range of wavelengths of light. These components may be incrementally rotated and at each different increment of rotation, a different transmission range of wavelengths of light can be achieved.

Various implementations may include one or more of the following features. The personal article may include a belt buckle, a cell phone, a media player, a mobile electronics device, jewelry, or sunglasses. The personal article may include a sensor configured to detect a condition and at least one of the adapters may be coupled to the sensor such that a change in the detected condition causes rotation of the adapter. The sensor may include at least one of a temperature sensor, a heart rate sensor, a pedometer, an accelerometer, a compass, or a global positioning sensor. At least one of the adapters may be configured to rotate or activate in response to a local or remote signal from a networked device.

In another general aspect, a personal article includes a liquid crystal layer and a retarder stack disposed in a cavity of the personal article. The retarder stack is proximate the liquid crystal layer. The personal article also includes one or more adapters operable to, when activated, alter the electromagnetic field applied to the liquid crystal layer, where the personal article transmits a first range of wavelengths of light and activation of the adapter causes the personal article to transmit a second range of wavelengths of light different from the first range of wavelengths of light. The liquid crystal layer and/or retarder stack may be incrementally activated (e.g., incrementally rotated, etc.) and at different increments of activation, a different transmission range of wavelengths of light can be achieved.

The details of one or more implementations are set forth in the accompanying drawings and the description below. Other features, objects, and advantages of the implementations will be apparent from the description and drawings, and from the claims.

### DESCRIPTION OF DRAWINGS

FIG. 1 illustrates an example of a timepiece.

FIG. 2 illustrates an example of a color changing system.

FIG. 3 illustrates an example of a color changing system.

FIG. 4 illustrates an example of a color changing system.

FIG. 5 illustrates an example of a color changing system.

Like reference symbols in the various drawings indicate like elements.

### DETAILED DESCRIPTION

Personal articles, such as timepieces (e.g., wristwatches, pocket watches, ring watches, etc.), belts, belt buckles, cell phones, media players, mobile electronics devices, jewelry, sunglasses, or portions of the personal articles, may be capable of changing color. The color change may be activated manually (e.g., by a user through an adapter or by turning a stem of a watch) or automatically (e.g., with a function of a timepiece such as the passage of time or through electronic control). The ability to change the appearance (e.g., color) of personal articles may increase the desirability of the personal article to the user and/or present a signal to the user (e.g., a specific time, the receipt of a text message, or a heart rate within a specified range).

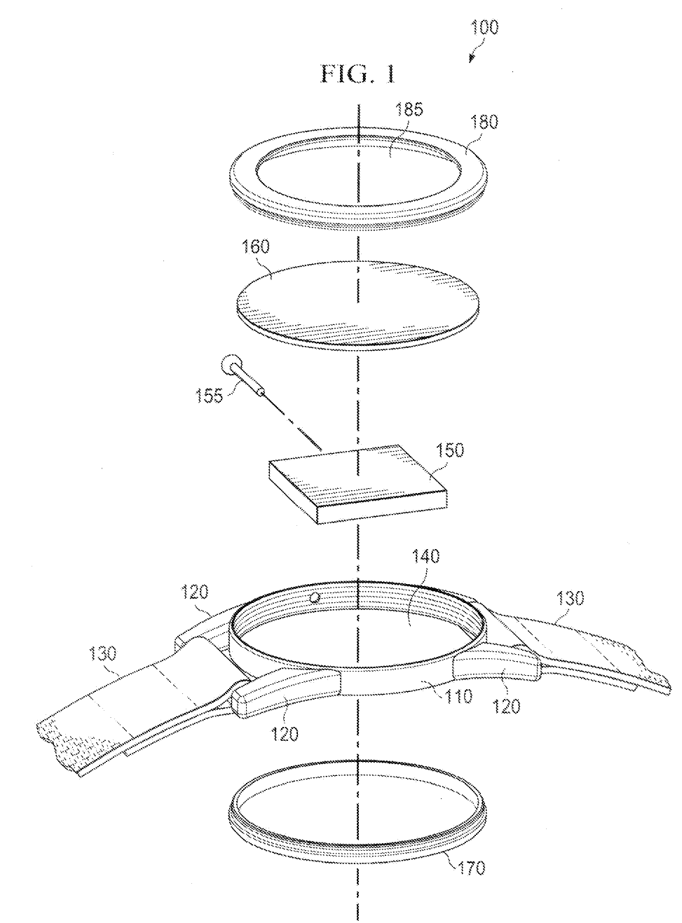

FIG. 1 illustrates an example timepiece that is a wristwatch 100. As illustrated, a watch 100 includes a case 110 disposed between lugs 120. The lugs 120 are coupled to an exterior surface of the case 110. One or more lugs 120 may be disposed on opposing sides of the case 110. The lugs 120 may couple (e.g., rotatably coupled, affixed, etc.) a band 130 to the case 110. A movement 150 and a color changing apparatus 160 may be at least partially disposed in a cavity 140 of the case 110. A stem 155 may be coupled to the movement 150 and/or color changing apparatus 160. A bezel 180 may be disposed above the movement 150 and/or color changing apparatus 160 and/or retain components (e.g., movement, stem, color changing apparatus, face, hands, etc.) at least partially in the cavity 140 of the case 110. The bezel 180 may include a recess (not shown) that is configured to receive a face, a watch crystal, color changing apparatus, etc. A portion of the bezel 180 may be threaded. The case 110 may be configured to receive at least a portion of the bezel 180 (e.g., the bezel may be screwed into the case). A caseback 170 may be coupled to a posterior of the case 110. The caseback 170 or a portion thereof may be adapted to be coupleable to the case 110. For example, a threaded portion of the caseback 170 may be received by a threaded portion of the case 110.

The watch 100 includes a case 110, lugs 120, and a band 130. The case 110 is coupled to the band using the lugs 120 and fasteners (not shown). The case 110 may be at least partially disposed between the lugs 120. The lugs 120 may be coupled to (e.g., attached, bonded, etc.) to the case 110 by fasteners. The lugs 120 may be, in some implementations, casted, for example, as part of the case 110.

The case 110 of the watch 100 includes a cavity 140 that receives a movement 150 of the watch 100 and at least a portion of a color changing apparatus 160. The cavity may also receive a face (not shown) and/or two or more hands (not shown).

A caseback 170 may be coupled to the case 110 and at least partially covers the backside of the case. The caseback or portions thereof may be transparent or translucent to, for example, allow a person to view components disposed in the case 110. The caseback may be a single piece or multiple pieces coupled together. For example, the caseback 170 may be a threaded ring and a backplate. The ring may couple the backplate to a posterior of the case to retain components disposed in a cavity of the case and/or inhibit components disposed in a cavity from passing through an opening of the ring or cavity of the case. As another example, the caseback 170 may be a single unit that retains components at least partially in a cavity of a case.

The movement 150 may be mechanical, electronic, or a combination thereof. A stem 155 may be coupled to the movement 150 to, for example, manually adjust a movement (e.g., to alter the time and/or date, to alter a timer, etc.). The stem 155 may also or alternatively be coupled to the color changing apparatus 160 to activate (e.g., cause a color change) the color changing apparatus 160.

In some implementations, the color changing apparatus 160 may be coupled to the movement 150, where the movement activates the color changing apparatus. For example, as a movement operates (e.g., moves the hands of the watch, adjusts the LCD display for an electronic watch), it may activate the color changing apparatus.

The face may reside adjacent the movement 150 of the watch 100 and/or include indicia such as numerals, images, or other indicia. The hands of the watch 100 may be objects or digitally displayed on the face. In some implementations, a watch 100, such as a digital watch, may not include hands but a numeric or other display (e.g., LED, OLED) of the time. In some implementations, a watch crystal may be disposed above the face. The watch crystal may be, for example, a Plexiglas disk, a mineral glass disk, and/or a sapphire (synthetic or natural) disk. The watch crystal may be at least partially disposed in a bezel and/or may inhibit damage to the color changing apparatus, the movement, the hands, and/or the face.

The case 110 also includes a bezel 180. The bezel 180 may be coupled to the case and/or be removable from the case. The bezel 180 may include an aperture 185 through which the face of the watch 100 may be viewed. For example, the aperture may allow viewing of the face of the watch through a transparent or translucent covering (e.g., watch crystal) disposed between the bezel 180 and the face. The bezel 180 may include a recess (not shown) configured to receive a covering such as a watch crystal, a color changing apparatus, and/or a face. When viewed through the aperture 185 of the bezel 180, the face may obscure at least a portion of the movement 150 of the watch 100. In addition, the bezel 180 may be rotatable. Rotation of the bezel may activate (e.g., cause a color alteration) the color changing apparatus.

The case 110, bezel 180, and/or aperture 185 may be, for example, circular as illustrated, square, octagonal, oval, irregularly shaped, or other appropriate shape.

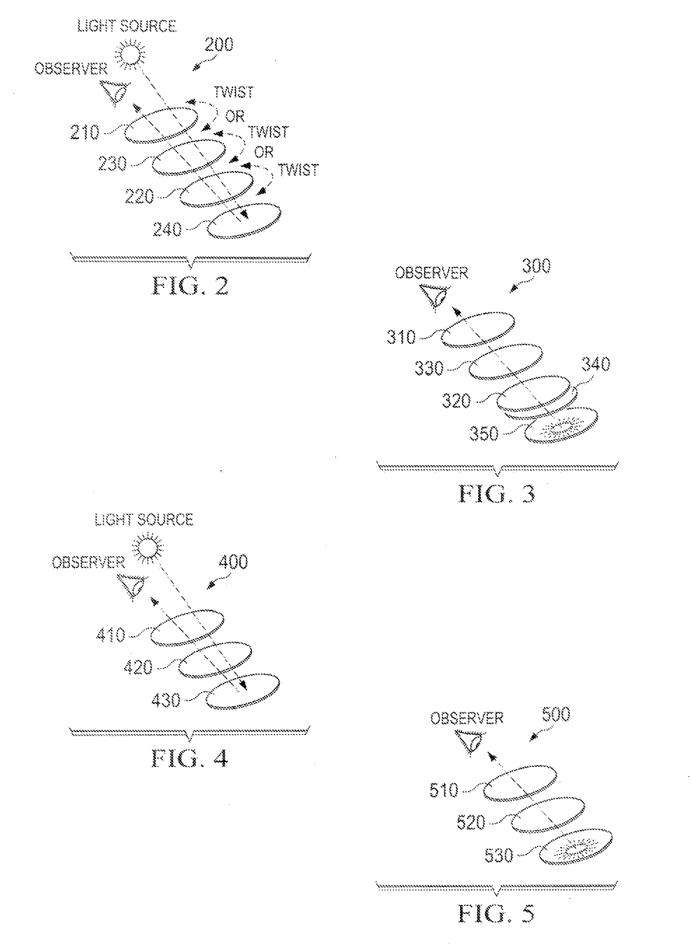

FIGS. 2-5 illustrate examples of color changing apparatuses in personal articles (e.g., timepieces, watches, etc.). During use, the color changing apparatus may allow modification of a color of at least a portion of a personal article. The color modification may be automatic and/or manual (e.g., a user may activate the color changing apparatus to modify the color).

FIG. 2 illustrates an example color changing apparatus 200. The color changing apparatus 200 may change the color of a portion of a timepiece, for example, when activated. For example, the color changing apparatus may include the face, be visible through the face, and/or allow the face to be visible. Activation of the color changing apparatus may adjust the color that the face appears to be to a user. As another example, the color changing apparatus may be visible through the caseback of the timepiece.

The color changing apparatus 200 includes a first polarizer 210, a second polarizer 220, and a retarder stack 230 disposed between the first and the second polarizer. A polarizer 210, 220 may be any material suitable to polarize light emitted from a light source (e.g., ambient light, LED or other light source in the watch cavity, etc.). The polarizer 210, 220 may be a lens, a film, a coating, or any other appropriate medium.

The retarder stack 230 may be a plurality of retarders (e.g., retarder films) coupled (e.g., affixed, adhered, bonded, etc.) together. The retarder stack may be a multilayer laminate of retardation films. The retarder stack may be able to convert one range of wavelengths of light to the orthogonal polarization, while leaving the state of polarization of the complementary color not significantly changed. The retarder stack may be able to modify the range of wavelengths of light without substantial loss. The retarder stack may be capable of resolving a polarized light beam into two orthogonal components, retard the phase of one component (e.g., a first range of wavelengths of light) relative to the other component (e.g., a second range of wavelengths of light), and then recombines the two to form a single beam with new polarization characteristics.

A retarder stack may be capable of half-wave or quarter-wave retardation. A half-wave retarder stack may reorient the plane of a linearly polarized input beam and a quarter-wave retarder stack may convert a linearly polarized input light into circularly polarized light, or vice versa. For example, the retarder stack 230 may be the retarder stack sold under the trademark ColorSelect, commercially available from ColorLink, Inc. (Boulder, Co) or ColorLink Japan, Ltd. (Joetsu City, Niigata Prefecture, Japan). As another example, the retarder stack 230 may be similar to the retarder stack described in U.S. Pat. No. 5,929,946 to Sharp et al. A retarder stack may allow a greater range of color changes and/or clearer color changes than a single retarder film or multiple retarder films.

A reflector 240 may be disposed proximate the second polarizer 220. The reflector may be a material capable of reflecting light, such as a mirror.

A reflector 240 may be disposed proximate the second polarizer 220. The reflector may be any material capable of reflecting or transmitting light, such as a mirror, paper, plastic, metal, a combination of materials, or any other surface that reflects any amount of ambient light.

Activation of the color changing apparatus may include activation of an adapter (not shown). Activation of the adapter may rotate at least one of the polarizers or the retarder stack.

Light from a light source, such as ambient light, may be emitted. The light may pass through the first polarizer 210 which polarizes the light. The polarized light is then transmitted through the retarder stack 230, which orthogonally polarizes at least a portion of the light. This modified light is then transmitted through a second polarizer 220, which polarizes the modified light. This light is reflected off the reflector 240, passes through the components of the color changing apparatus, and is viewable. The light from the light source is a first range of wavelengths of light and passage through the color changing apparatus causes the light to be modified such that a second range of wavelengths of light different from the first range of wavelengths of light is reflected and transmitted to be viewed (e.g., by a user).

Upon activation, at least one of the polarizers 210, 220 or retarder stack 230 may be rotated such that the orientation of the polarizers and retarder stack, with respect to each other, is modified. Thus, since the orientation of the polarizers and retarder stacks has been modified, as light passes through the polarizers, 210, 220 and the retarder stack 230, the modification of the light is different from the previous modification (e.g., prior to activation) of the light, and a different range of wavelengths of light may be transmitted through the color changing apparatus.

As an illustration, light from the sun may pass through and be altered by the color changing device, such that blue light is emitted from the color changing apparatus. When the color changing device is activated, at least one of the polarizers or retarder stack may be rotated and a second light color, such as red, is emitted from the color changing apparatus. The color emitted or transmitted from the color changing apparatus may be based on the orientation of the polarizers and retarder stack in relation to each other. Thus, additional rotation of at least one of the polarizers or retarder stacks may cause a different color to be emitted from the color changing apparatus.

Although the above description illustrates two polarizers, one polarizer or more than two polarizers may be used. For example, if the light source is polarized, one polarizer may be used. As another example, three or four polarizers may be used. In addition, one or more of the polarizers may be coupled (e.g., affixed, bonded, etc.) to the retarder stack and/or the reflector. In addition, one of the polarizers may be a polarizing reflector. A separate reflector may not be utilized when a polarizing reflector is used.

In addition, a reflector may not be utilized. When a reflector is not utilized, the color of the timepiece and/or changes to the color of the timepiece may be observed from the front (e.g., the bezel side) or the back (e.g., the case back) of the timepiece. The light from the light source may not be emitted from the same side of the timepiece as the color change is observed.

Furthermore, the color changing apparatus may allow incremental rotation. At each different increment of activation, a different transmission range of wavelengths of light can be achieved. Components such as polarizers and/or retarders may be rotated in increments and at each different increment of rotation, a different transmission range of wavelengths of light can be achieved. For example, a retarder stack in a timepiece may be rotated 360 degrees. A first range of wavelengths of light may be transmitted initially (e.g., such that a first color is visible to a user) and if the retarder stack is rotated at an increment (e.g., half a degree, five degrees, etc.) a second range of wavelengths of light is transmitted that is different from the first range. Thus, a different color may be visible to a user after the rotation. Allowing incremental rotation may allow a broader range of colors to be visible to the user through rotation of, for example, the retarder stack or polarizer. For example, when a timepiece is initially viewed, it may include a red portion and, after rotation of an increment, the red portion may appear to be orange. After another rotation of an increment, the orange portion may appear to be green, and further rotation may allow transmission of other colors or shades of colors.

In some implementations, adapters are coupled to and operable to rotate one of polarizers or the retarder stack, where the personal article transmits a first range of wavelengths of light and rotation causes the personal article to transmit a second range of wavelengths of light different from the first range of wavelengths of light. These components may be incrementally rotated and at each different increment of rotation, a different transmission range of wavelengths of light can be achieved.

FIG. 3 illustrates an example of a color changing apparatus 300. The color changing apparatus 300 includes a first polarizer 310, a second polarizer 320, and a retarder stack 330 disposed at least partially between the first and the second polarizer. A translucent plate 340 (e.g., film, lens, coating, etc.) may be disposed proximate the second polarizer 320. The translucent plate may include a translucent portion or a translucent portion and a non-translucent portion. The translucent plate may include the face for a watch or other insignia, such as images and/or text. The insignia (e.g., images and/or text, such as pictures, the face or the hands of the watch, etc.) may be disposed on the translucent portion or non-translucent portion. Images and/or text (e.g., pictures, patterns, collegiate symbols, numbers, letters, etc.) on the translucent portion may change colors upon activation of the color changing apparatus. Images and/or text on the non-translucent portion may not change colors upon activation of the color changing apparatus.

In some implementations, the translucent plate may not be included in the color changing apparatus. In some implementations, multiple translucent plates with filters may be used such that different images are displayed when different range of wavelengths of light pass through the translucent plate.

A light source 350 may be disposed proximate the translucent plate 340 and second polarizer 320. The light source 350 may be any suitable light source, such as a light emitting diode. The light may be, for example, a colored light source (e.g., a blue light emitting diode) or a white light source.

Activation of the color changing apparatus may include activation of an adapter (not shown). Activation of the adapter may rotate at least one of the polarizers or the retarder stack.

At least a portion of the light from the light source 350 may pass through the translucent plate 340. The light may then be polarized as it is transmitted through the second polarizer 320. The retarder stack 330 may orthogonally polarize at least a portion of the light that is transmitted through the retarder stack. This light may then be polarized by the first polarizer 310 as it is transmitted through the first polarizer. Light modified by the color changing apparatus may then be viewed.

Upon activation of the color changing apparatus, such as by rotating a first polarizer, the orientation of the first polarizer to the retarder stack and the second polarizer may be modified. Thus, the color of the light emitted by the color changing apparatus may be different from the color previously emitted prior to activation. As the orientation of the first polarizer to the other components of the color changing apparatus is modified, the color of the light emitted from the color changing apparatus may be modified.

Thus, as an example, when a user activates the color changing apparatus by rotating the first polarizer twenty degrees, a red light may be emitted from the color changing apparatus. When a user further activates the color changing apparatus by rotating the first polarizer an additional number of degrees (e.g., 10, 25, 40), a second color of light, such as yellow, may be emitted from the color changing apparatus.

FIG. 4 illustrates an example of a color changing apparatus 400. The color changing apparatus 400 includes a liquid crystal layer 410, a retarder stack 420, and a reflector 430. The retarder stack 420 may be disposed between the liquid crystal layer 410 and the reflector 430. The liquid crystal layer may be a layer of a twisted nematic (TN) or super-twisted nematic (STN) liquid crystals, for example. Activation of the color changing apparatus may include activation of an adapter. The adapter (e.g., bezel, stem, or microcontroller) may electronically alter the orientation of the crystals in the liquid crystal layer by altering the electromagnetic field applied to the liquid crystal layer.

Light, such as ambient light, may be modified and transmitted through the liquid crystal layer 410. The retarder stack 420 may orthogonally polarize at least a portion of the light that is transmitted through the retarder stack. The modified light is then reflected off the reflector 430. Upon activation, the electromagnetic field applied to the liquid crystal layer may be modified and, thus, the orientation of the crystals in the liquid crystal layer with respect to the retarder stack may be modified. The modification of the orientation may alter the modification of the light passing through the color changing apparatus and the color viewable to a user.

FIG. 5 illustrates an example of a color changing apparatus 500 for a timepiece. The color changing apparatus 500 includes a liquid crystal layer 510, a retarder stack 520, and a light source 540. Activation of the color changing apparatus 500 may alter the electromagnetic field applied to the liquid crystal layer 510 to change the orientation of the liquid crystals, with respect to the retarder stack.

Light emitted from the light source 530, such as a light bulb, is transmitted through the retarder stack 520, which orthogonally polarizes at least a portion of the light. Another portion of the light may not be polarized by the retarder stack 520. The liquid crystal layer then modifies the light based on the electromagnetic field applied to it. As the electromagnetic field is varied, the modification of the light passing through the color changing apparatus varies, and the color visible to a user varies with the modification.

Furthermore, the color changing apparatus may allow incremental rotation. At each different increment of activation, a different transmission range of wavelengths of light can be achieved. The liquid crystal layer may be activated in increments (e.g., the electromagnetic field applied to the liquid crystal layer may be incrementally adjusted) and at each different increment of rotation, a different transmission range of wavelengths of light can be achieved. For example, a liquid crystal layer in a timepiece may be incrementally activated such. A first range of wavelengths of light may be transmitted initially (e.g., such that a first color is visible to a user) and if the liquid crystal layer is activated at an increment (e.g., half a degree, five degrees, etc.) a second range of wavelengths of light is transmitted that is different from the first range. Thus, a different color may be visible to a user after the rotation. Allowing incremental activation may allow a broader range of colors to be visible to the user. For example, when a timepiece is initially viewed it may include a red portion and after the liquid crystal layer is activated at an increment the red portion may appear to be orange. After another activation of an increment, the orange portion may appear to be green, and further activation may allow transmission of other colors or shades of a color.

FIG. 5 illustrates an example of a color changing apparatus 500. The color changing apparatus 500 includes a liquid crystal layer 510, a retarder stack 520, and a light source 530. Activation of the color changing apparatus 500 may alter the electromagnetic field applied to the liquid crystal layer 510 to change the orientation of the liquid crystals with respect to the retarder stack.

Light emitted from the light source 530, such as a light bulb or LED, is transmitted through the retarder stack 520, which orthogonally polarizes at least a portion of the light. Another portion of the light may not be polarized by the retarder stack 520. The liquid crystal layer then modifies the light based on the electromagnetic field applied to it. As the electromagnetic field is varied, the modification of the light passing through the color changing apparatus varies, and the color visible to a user varies with the modification.

A number of implementations have been described. Nevertheless, it will be understood that various modifications may be made without departing from the spirit and scope of the concepts described herein. Accordingly, other implementations are within the scope of this application.

In addition, the adapter may be coupled to another component of the timepiece or external to the timepiece, where a signal from the component automatically or manually activates the color changing apparatus. For example, the component may be a movement of a watch, and as the movement operates (e.g., the hands on a watch), the adapter may be activated. Thus, as the time changes, the color of the watch may change (e.g., every hour, second, or minute the color changes, every switch between am and pm the color changes, etc.). As another example, the component may be a sensor that is coupled to the timepiece (e.g., directly or indirectly through network protocol, such as Wi-Fi or Bluetooth®). As the sensor monitors a condition, changes in the condition or a specified change in the condition may activate the color change apparatus. For example, the sensor may be a heart rate sensor and, as a heart rate in a specified range is detected, a specified color may be displayed on the timepiece through the color changing apparatus. In addition, a sensor monitoring incoming calls may be used and when an incoming call on a coupled phone or personal digital assistant is detected, a specified color may be displayed through the color changing apparatus.

In addition, the timepiece may transmit a first range of wavelengths of light and rotation may cause the timepiece to transmit a second range of wavelengths of light different from the first range of wavelengths of light. The timepiece may allow incremental rotation, where at each incremental rotation, a different range of wavelengths of light may be transmitted (e.g., at each different increment, a different transmission range of wavelengths can be achieved). For example, a wristwatch may include an adapter that allows a retarder stack to be incrementally rotated 360 degrees. As the retarder stack is rotated 5 degrees, for example, a color change may be apparent to a user. As another example, a pocket watch may include a liquid crystal layer and a retarder stack proximate the liquid crystal layer. The pocket watch may include an adapter that is able to incrementally activate the liquid crystal layer (e.g., incrementally alter the electromagnetic field applied to the liquid crystal layer) such that different ranges of wavelengths of light may be transmitted at different increments.

In some implementations, the color changing capabilities of the timepiece may increase the use of the timepiece by a user, increase desirability of the article (e.g., since it can color change to compliment other personal articles), and/or increase functionality (e.g., since it may alert a user about, for example, times, heart rates, etc.).

The timepiece may include a sensor and/or a microcontroller (e.g., any appropriate programmable logic device) that detects a condition. When the condition (e.g., heart rate, position, temperature, touch, velocity, etc.) is detected, an adapter coupled to the sensor or microcontroller may cause activation of the color changing apparatus (e.g., electric rotation of a retarder stack or polarizer, change in electromagnetic field applied to a liquid crystal layer). The sensor may include a touch sensor, temperature sensor, a heart rate sensor, a pedometer, an accelerometer, a compass, and/or a global positioning sensor. In some implementations, at least one of the adapters is coupled to a microcontroller and the microcontroller is configured to rotate the adapter in response to a signal from a network device (e.g., wireless, Bluetooth®, IR, wired, etc.).

The color changing apparatus of FIGS. 2-5 or similar color changing apparatus may be used in other personal accessories. For example, a belt buckle or portions of a belt buckle may include a color changing apparatus. A button or stem may be used to activate the color changing apparatus. In addition, a portion of a component (e.g., a polarizer) may be accessible through an opening in the belt buckle and rotated manually to activate a color change.

As another example, at least a portion of a cell phone may include the color changing apparatus. For example, the case of the cellular phone may be color changeable using the color changing apparatus. In addition, jewelry such as earrings, necklaces, bracelets, etc. may include color changing apparatus. The jewelry may be color modified by a user to complement clothing or other personal articles. Thus, a single jewelry collection (e.g., earrings, necklace, bracelet) may be more extensively utilized since its color is changeable.

As an example, a personal article includes a first polarizer, a second polarizer, a retarder stack and at least one adapter. The first polarizer and/or second polarizer may polarize light from a light source. A retarder stack, disposed between the first polarizer and the second polarizer, may orthogonally polarize at least a portion of light from the light source. Each adapter may be coupled to and operable to rotate one of: the first polarizer the second polarizer, a third polarizer, or a retarder stack. As another example, the personal article may include a liquid crystal layer (e.g., a twisted nematic liquid crystal layer or super-twisted nematic liquid crystal layer) disposed in a cavity of the personal article, a retarder stack disposed in the cavity and proximate the liquid crystal layer, and at least one adapter. Each adapter may, when activated, alter the electromagnetic field applied to the liquid crystal layer.

The personal article may transmit a first range of wavelengths of light and rotation may cause the personal article to transmit a second range of wavelengths of light different from the first range of wavelengths of light. The personal article may allow incremental rotation, where at each incremental rotation, a different range of wavelengths of light may be transmitted (e.g., at each different increment, a different transmission range of wavelengths can be achieved). For example, a ring may include an adapter that allows a retarder stack to be incrementally rotated 360 degrees. As the retarder stack is rotated 5 degrees, for example, a color change may be apparent to a user. As another example, a media player may include a liquid crystal layer and a retarder stack proximate the liquid crystal layer. The media player may include an adapter that is able to incrementally activate the liquid crystal layer (e.g., incrementally alter the electromagnetic field applied to the liquid crystal layer) such that different ranges of wavelengths of light may be transmitted at different increments.

In some implementations, the personal article may include a belt buckle, a cell phone (e.g., smart phone, cellular phone, etc.), a media player, jewelry, a mobile electronic device (e.g., personal digital assistant), and/or sunglasses. The mobile electronic device, media player, and/or cell phone may, for example, be either worn or carried. Thus, color changing capabilities of the personal article may increase the use of the personal article by a user, increase desirability of the article (e.g., since it can color change to compliment other personal articles), and/or increase functionality (e.g., since it may alert a user about, for example, times, heart rates, etc.).

The personal article may include a sensor and/or a microcontroller (e.g., any appropriate programmable logic device) that detects a condition. When the condition (e.g., heart rate, position, temperature, touch, velocity, etc.) is detected, an adapter coupled to the sensor or microcontroller may cause activation of the color changing apparatus (e.g., electric rotation of a retarder stack or polarizer, change in electromagnetic field applied to a liquid crystal layer). The sensor may include a touch sensor, temperature sensor, a heart rate sensor, a pedometer, an accelerometer, a compass, and/or a global positioning sensor. In some implementations, at least one of the adapters is coupled to a microcontroller and the microcontroller is configured to rotate the adapter in response to a signal from a wireless or other network device.

A number of implementations have been described. Nevertheless, it will be understood that various modifications may be made without departing from the spirit and scope of the concepts described herein. Accordingly, other implementations are within the scope of this application.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an,” and “the” include plural references unless the content clearly indicates otherwise. Thus, for example, reference to “a polarizer” includes a combination of two or more polarizers and reference to “a light source” includes different types of light sources.

1. A timepiece comprising:
a first polarizer configured to polarize light from a light source;
a second polarizer configured to polarize light from a light source;
a retarder stack disposed between the first polarizer and the second polarizer and configured to orthogonally polarize at least a portion of light from the light source; and
one or more adapters coupled to and operable to rotate one of: the first polarizer, the second polarizer, or the retarder stack, wherein the timepiece transmits a first range of wavelengths of light and rotation causes the timepiece to transmit a second range of wavelengths of light different from the first range of wavelengths of light.

2. The timepiece of claim 1 further comprising a movement, wherein the movement is disposed proximate at least one of the first or the second polarizer.

3. The timepiece of claim 2 wherein the movement is operable to rotate one of the adapters, and wherein the second range of wavelengths of light transmitted by the timepiece upon rotation changes as the movement rotates the adapter.

4. The timepiece of claim 1 further comprising insignia, wherein rotation causes the insignia to change colors due to the transmission of the second range of wavelengths of light.

5. The timepiece of claim 1 further comprising an insignia and a background, wherein rotation causes the background to change colors due to the transmission of the second range of wavelengths of light, and wherein rotation does not affect the transmission of light by the insignia.

6. The timepiece of claim 1 wherein at least one of the adapters comprises at least one of a bezel of a watch or a stem of a watch.

7. The timepiece of claim 1 wherein at least one of the adapters comprises a portion of at least one of the first polarizer, the second polarizer, or the retarder stack, the portion accessible to a user.

8. The timepiece of claim 1 further comprising at least one of:
a light source disposed in a cavity of the timepiece and proximate the second polarizer; or
a reflector disposed in the cavity of the timepiece and proximate the second polarizer.

9. The timepiece of claim 1 further comprising at least one of a sensor or a microcontroller configured to detect a condition, and wherein at least one of the adapters is coupled to at least one of the sensor or the microcontroller such that a change in the detected condition causes electronic rotation of the adapter.

10. The timepiece of claim 9 wherein the sensor comprises at least one of a touch sensor, a temperature sensor, a heart rate sensor, a pedometer, an accelerometer, a compass, or a global positioning sensor.

11. The timepiece of claim 1 wherein at least one of the adapters is coupled to a microcontroller configured to rotate the coupled adapter in response to a signal from a network device.

12. A timepiece comprising:
a liquid crystal layer disposed in a cavity of the timepiece;
a retarder stack disposed in the cavity and proximate the liquid crystal layer; and
one or more adapters operable to, when activated, alter the electromagnetic field applied to the liquid crystal layer, wherein the timepiece transmits a first range of wavelengths of light and activation of the adapter causes the timepiece to transmit a second range of wavelengths of light different from the first range of wavelengths of light.

13. (canceled)

14. (canceled)

15. The timepiece of claim 14 wherein the movement is operable to activate one of the adapters, and wherein the second range of wavelengths of light transmitted by the timepiece upon rotation changes as the movement activates the adapter.

16. The timepiece of claim 12 further comprising insignia, wherein activation causes the insignia to change colors due to the transmission of the second range of wavelengths of light.

17. The timepiece of claim 12 further comprising an insignia and a background, wherein rotation causes the background to change colors due to the transmission of the second range of wavelengths of light, and wherein rotation does not affect the transmission of light by the insignia.

18. (canceled)

19. The timepiece of claim 12 further comprising at least one of:
a light source disposed in a cavity of the timepiece and proximate the retarder stack; or
a reflector disposed in the cavity of the timepiece and proximate the retarder stack.

20. The timepiece of claim 12 further comprising at least one of a sensor or a microcontroller configured to detect a condition, and wherein at least one of the adapters is coupled to at least one of the sensor and/or the microcontroller such that a change in the detected condition causes electronic rotation of the adapter.

21. (canceled)

22. The timepiece of claim 12 wherein at least one of the adapters is coupled to a microcontroller configured to activate the coupled adapter in response to a signal from a network device.

23. A personal article comprising:
a first polarizer configured to polarize light from a light source;
a second polarizer configured to polarize light from a light source;
a retarder stack disposed between the first polarizer and the second polarizer and configured to orthogonally polarize at least a portion of light from the light source; and
one or more adapters coupled to and operable to rotate one of: the first polarizer, the second polarizer, or the retarder stack, wherein the personal article transmits a first range of wavelengths of light and rotation causes the personal article to transmit a second range of wavelengths of light different from the first range of wavelengths of light.

24. The personal article of claim 23 wherein the personal article comprises at least one of a belt buckle, a cell phone, a media player, a mobile electronic device, jewelry, or sunglasses.

25. The personal article of claim 23 further comprising at least one of a sensor or a microcontroller configured to detect a condition, and wherein at least one of the adapters is coupled to at least one of the sensor or the microcontroller such that a change in the detected condition causes electronic rotation of the adapter.

26. (canceled)

27. The personal article of claim 23 wherein at least one of the adapters is coupled to a microcontroller configured to rotate the coupled adapter in response to a signal from a network device.

28. A personal article comprising:
a liquid crystal layer disposed in a cavity of the personal article;
a retarder stack disposed in the cavity and proximate the liquid crystal layer; and
one or more adapters operable to, when activated, alter the electromagnetic field applied to the liquid crystal layer, wherein the personal article transmits a first range of wavelengths of light and activation of the adapter causes the personal article to transmit a second range of wavelengths of light different from the first range of wavelengths of light.

29. (canceled)

30. (canceled)

31. The personal article of claim 28 further comprising at least one of a sensor or a microcontroller configured to detect a condition, and wherein at least one of the adapters is coupled to at least one of the sensor and/or the microcontroller such that a change in the detected condition causes electronic activation of the adapter.

32. (canceled)

33. The personal article of claim 28 wherein at least one of the adapters is connected to a microcontroller configured to activate the coupled adapter in response to a signal from a network device.
